(19) United States
(12) Patent Application Publication
(10) Pub. No.: US 2020/0304393 A1
(43) Pub. Date: Sep. 24, 2020

(54) NETWORK TRAFFIC TRENDS VISIBILITY

(71) Applicant: HEWLETT PACKARD ENTERPRISE DEVELOPMENT LP, Houston, TX (US)

(72) Inventors: Rangaprasad SAMPATH, Bangalore (IN); Madhusoodhana Chari SESHA, Bangalore (IN); Srinidhi Hari PRASAD, Bangalore (IN)

(21) Appl. No.: 16/357,873

(22) Filed: Mar. 19, 2019

(51) Int. Cl. H04L 12/26; H04L 12/24; G06N 20/00

(52) U.S. Cl. CPC H04L 43/0894; G06N 20/00; H04L 41/16; H04L 43/062

(57) ABSTRACT

A device may track network traffic and may determine sample points associated with a plurality of time intervals, where each sample point from the plurality of sample points that is associated with a respective time interval from the plurality of time intervals comprises a count of packet lengths associated with a plurality of packets that comprise at least a specified portion of total network volume for the respective time interval and a total number of packet lengths observed during the respective time interval. The device may generate a plurality of clusters of the plurality of sample points and may, in response to determining a plurality of new sample points associated with a plurality of new time intervals based on the network traffic, determine a network traffic trend for the network based at least in part on a distribution of the plurality of new sample points within the plurality of clusters.

### BACKGROUND

A network, also referred to as a computer network or a data network, is a digital telecommunications network which allows nodes (e.g., computing devices, network devices, etc.) to share resources. In networks, nodes exchange data with each other using connections (e.g., data links) between nodes. These connections can be established over cable media such as wires or optic cables, or wireless media such as Wi-Fi.

The description provided in the background section should not be assumed to be prior art merely because it is mentioned in or associated with the background section. The background section may include information that describes one or more aspects of the subj ect technology.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for determining network traffic trends of a network.

FIG. 2 is a block diagram illustrating the example network device from the architecture of FIG. 1 according to certain aspects of the disclosure.

FIG. 3 illustrates a histogram of the number of packets of each of the packet lengths encountered in a network during a time interval.

FIG. 4A illustrates an example table of the different packet lengths of data packets encountered by an example network device during an example time interval.

FIG. 4B illustrates an example table of example sample points associated with an example plurality of time intervals.

FIG. 5A illustrates an example visual representation of example sample points associated with example time intervals that are plotted in an example graph.

FIG. 5B illustrates example clusters of example sample points plotted in the example graph of FIG. 5A.

FIG. 6 illustrates an example process for determining network traffic trends using the example network device of FIGS. 1 and 2.

FIG. 7 is a block diagram illustrating an example computer system with which the example network device of FIGS. 1 and 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

The disclosed system provides for tracking of network traffic to determine a network traffic trend of the network that may be used to monitor various characteristics associated with the network, such as the network capacity of the network, as well as to increase the security, reliability, and resource utilization of the network. The disclosed system may track network traffic over multiple time intervals and may determine network traffic trends based on the statistical properties and/or attributes associated with data packets sent and received in the network during the multiple time intervals.

In particular, the disclosed system may determine sample points associated with the time intervals based on relationships between the packet length of data packets of network traffic and volumes of network traffic during each of the time intervals, and may use an unsupervised machine learning mechanism to generate clusters of the sample points. The disclosed system may continue to track the network traffic of the network over additional time intervals, determine additional sample points associated with the additional sample points, and determine network traffic trends for the network based on the distribution of the additional sample points within the clusters. The disclosed system may use the network traffic trends to improve network performance, such as by being used for network provisioning determinations, security profiling determinations, network anomaly identification, and bandwidth allocation determinations, among others.

The disclosed system may be used to determine network traffic trends across network deployments that may vary significantly. For example, a network at an airport may experience a wide churn in users that connect to the network for relatively short durations as the users wait for their flights, while a network at a university may experience groups of users connected to the network that change at fixed times between various buildings as classes are held at various locations on the university's campus. However, condition-based programmatic techniques may not be able to reliably determine network trends across such widely varying network deployments.

The disclosed system provides potential technical advantages over such condition-based programmatic techniques for determining network trends of a network. For example, because the disclosed system collects statistical properties and/or attributes associated with network traffic over multiple time intervals and utilizes an unsupervised machine learning mechanism to determine network trends from such collected data, the disclosed system may be able to continuously observe network usage, recognize patterns from such network usage, and transform the recognized pattern into meaningful insights, the disclosed system is able to be used across a diverse variety of network deployments.

Aspects of the disclosed system are necessarily rooted in computer technology to overcome a technical problem specifically arising in the realm of computer networks, namely the problem of determining network traffic trends for a network. Aspects of the disclosed system solves this technical problem by determining relationships between the packet length of data packets and volumes of network traffic to generate sample points for time intervals, using machine learning to generate clusters of the sample points, and determine network traffic trends for the network based on the distribution of additional sample points within the clusters. The disclosed system may use the determined network traffic trends for effective network provisioning, network usage forecast, and network capacity planning, as well as to detect potential security events occurring at the network and to determine whether provisioned security measures have mitigated the potential security events.

Aspects of the disclosed system also integrate an unsupervised machine learning mechanism into a practical application. For example, the disclosed system may use the clusters of sample points generated using the unsupervised machine learning mechanism to determine network traffic trends for the network based on the distribution of additional sample points within the clusters, which is one of the practical applications of using the unsupervised machine learning mechanism as described herein.

According to certain aspects of the present disclosure, a computer-implemented method for determining network traffic trends is provided. The method includes tracking network traffic within a network. The method further includes determining, based at least in part on the tracked network traffic, a plurality of sample points associated with a plurality of time intervals, wherein each sample point from the plurality of sample points that is associated with a respective time interval from the plurality of time intervals comprises a count of packet lengths associated with a plurality of packets that comprise at least a specified portion of total network volume for the respective time interval and a total number of different packet lengths observed during the respective time interval. The method further includes generating, using an unsupervised machine learning mechanism, a plurality of clusters of the plurality of sample points. The method further includes in response to determining a plurality of new sample points associated with a plurality of new time intervals based at least in part on the network traffic, determining a network traffic trend for the network based at least in part on determining a distribution of the plurality of new sample points within the plurality of clusters.

According to certain aspects of the present disclosure, a system is provided. The system includes a memory comprising instructions. The system further includes a processor configured to execute the instructions which, when executed, cause the processor to: track network traffic within a network; determine, based at least in part on the tracked network traffic, a plurality of sample points associated with a plurality of time intervals, wherein each sample point from the plurality of sample points that is associated with a respective time interval from the plurality of time intervals comprises a count of packet lengths associated with a plurality of packets that comprise at least a specified portion of total network volume for the respective time interval and a total number of different packet lengths observed during the respective time interval; generate, using an unsupervised machine learning mechanism, a plurality of clusters of the plurality of sample points; and in response to determining a plurality of new sample points associated with a plurality of new time intervals based at least in part on the network traffic, determine a network traffic trend for the network based at least in part on determining a distribution of the plurality of new sample points within the plurality of clusters.

According to certain aspects of the present disclosure, a non-transitory machine-readable storage medium comprising machine-readable instructions for causing a processor to execute a method for determining network trends is provided. The method includes tracking network traffic within a network. The method further includes determining, based at least in part on the tracked network traffic, a plurality of sample points associated with a plurality of time intervals, wherein each sample point from the plurality of sample points that is associated with a respective time interval from the plurality of time intervals comprises a count of packet lengths associated with a plurality of packets that comprise at least a specified portion of total network volume for the respective time interval and a total number of different packet lengths observed during the respective time interval. The method further includes generating, using an unsupervised machine learning mechanism, a plurality of clusters of the plurality of sample points. The method further includes in response to determining a plurality of new sample points associated with a plurality of new time intervals based at least in part on the network traffic, determining a network traffic trend for the network based at least in part on determining a distribution of the plurality of new sample points within the plurality of clusters.

According to certain aspects of the present disclosure, an apparatus is provided. The apparatus includes means for tracking network traffic within a network. The apparatus further includes means for determining, based at least in part on the tracked network traffic, a plurality of sample points associated with a plurality of time intervals, wherein each sample point from the plurality of sample points that is associated with a respective time interval from the plurality of time intervals comprises a count of packet lengths that together contributed to at least a specified portion of total network volume for the respective time interval and a total number of different packet lengths observed during the respective time interval. The apparatus further includes means for generating, using an unsupervised machine learning mechanism, a plurality of clusters of the plurality of sample points. The apparatus further includes means for in response to determining a plurality of new sample points associated with a plurality of new time intervals based at least in part on the network traffic, determining a network traffic trend for the network based at least in part on determining a distribution of the plurality of new sample points within the plurality of clusters.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### Example System Architecture

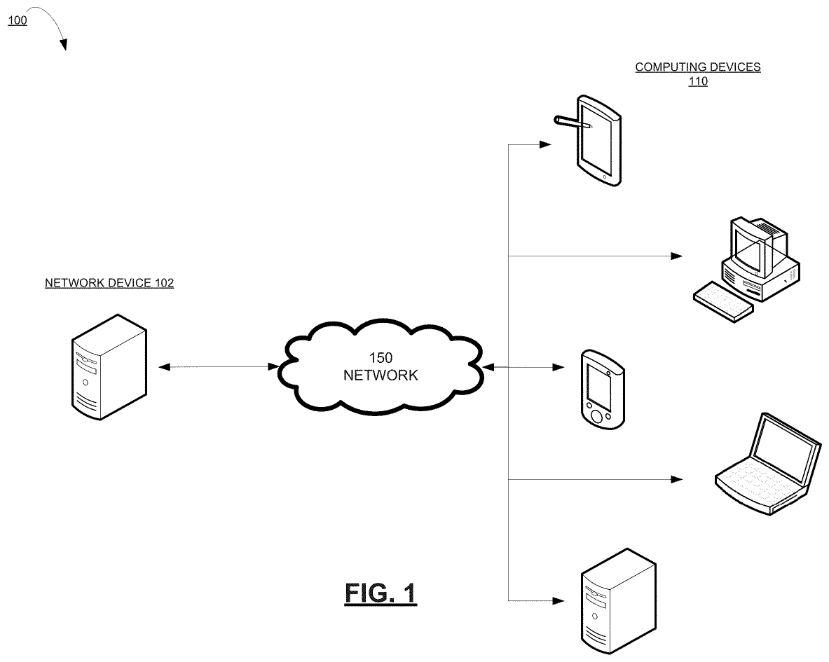

FIG. 1 illustrates an example architecture 100 for determining network traffic trends. As shown in FIG. 1, architecture 100 includes network device 102 and computing devices 110 connected over network 150.

Network 150 can include, for example, a local area network (LAN) or a portion of a LAN. Network device 102 may be any suitable network device, such as a router, a switch, an access point (e.g., a WiFi access point), and the like. Computing devices 110 can be, for example, desktop computers, mobile computers, tablet computers (e.g., including e-book readers), mobile devices (e.g., a smartphone or PDA), set top boxes (e.g., for a television), video game consoles, or any other devices having appropriate processor, memory, and communications capabilities to connect to network 150 and to send and receive data via network 150. In some examples, computing devices 110 may include one or more network devices, such as one or more routers, switches, access points, and the like.

As computing devices 110 operate as they are connected to network 150, computing devices 110 may create network traffic within network 150 by sending and receiving data via network 150. When network device 102 acts as a network router, a network switch, or another suitable network device, network device 102 may encounter the network traffic within network 150, such as by receiving the data sent and received by computing devices 110 as it performs its functions of network switching and/or network routing.

In accordance with aspects of the present disclosure, network device 102 may track the network traffic within network 150 and may determine a network trend for network 150 based on the network traffic tracked by network device 102. Network device 102 may track the network traffic continuously over time, and may separate the network traffic it tracks into time intervals, such ten, fifteen, or twenty minute intervals.

To track the network traffic for a time interval, network device 102 may track the data packets within the network traffic for the time interval. In particular, network device 102 may determine, for each data packet of the network traffic, the packet length of the data packet, which may be the data size of the data packet in bytes. Network device 102 may determine the number of different packet lengths encountered during the time interval, and may also determine the number of data packets of each of the different packet lengths encountered during the time interval.

Network device 102 may determine, based at least in part on the tracked network traffic, a plurality of sample points associated with a plurality of time intervals, wherein each sample point from the plurality of sample points that is associated with a respective time interval from the plurality of time intervals comprises a count of packet lengths that together contributed to at least a specified portion of total network volume for the respective time interval and a total number of different packet lengths observed during the respective time interval.

In this way, network device 102 generates a plurality of sample points associated with a plurality of time intervals, so that each sample point represents a time interval. Network device 102 may use an unsupervised machine learning mechanism to generate a plurality of clusters of the plurality of sample points. Network device 102 may, in response to determining a plurality of new sample points associated with a plurality of new time intervals based at least in part on the network traffic, determine a network traffic trend for the network based at least in part on determining a distribution of the plurality of new sample points within the plurality of clusters.

### Example System for Determining Network Traffic Trends

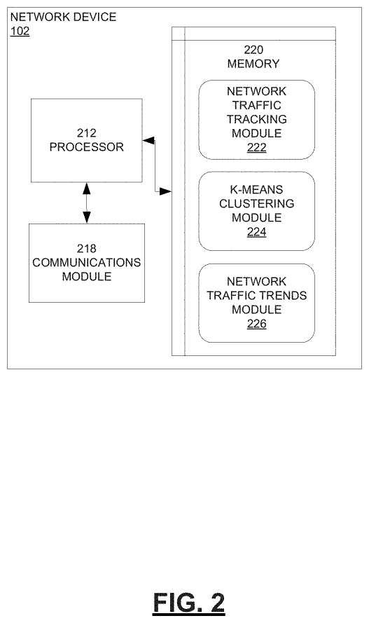

FIG. 2 is a block diagram illustrating an example network device 102 in the architecture 100 of FIG. 1 according to certain aspects of the disclosure. As shown in FIG. 2, network device 102 includes a processor 212, a communications module 218, and a memory 220 that includes network traffic tracking module 222, k-means clustering module 224, and network traffic trends module 226.

Communications module 218 and send and receive data over network 150 as network device 102 operates. For example, communications module 218 may send and receive data as part of performing its functionality as a network switch, a network router, an access point, and the like. Data sent and received by communications module 218 is referred to herein as data or data packets that are encountered by network device 102.

Processor 212 of network device 102 is configured to execute instructions, such as instructions physically coded into the processor 212, instructions received from software in memory 220, or a combination of both. For example, the processor 212 of the network device 102 executes instructions to tracking network traffic within network 150. Tracking the network traffic within network 150 may include tracking the data packets being sent and received within network 150, including data packets that network device 102 encounters via communications module 218 as it performs its functionality of network switching or network routing. For example, network device 102 may encounter data packets sent and received by computing devices 110 or may encounter data packets that are forwarded from one or more of computing devices 110.

Network device 102 may continuously track the network traffic as network device 102 operates, and may divide the tracked network traffic into respective time intervals during which network device 102 encounters the network traffic. Examples of time intervals may include ten minute time intervals, fifteen minute time intervals, thirty minute time intervals, and the like. Thus, if network device 102 segments the tracked network traffic into fifteen time intervals, network device 102 may group the network traffic that is tracked during the first fifteen minutes into a first time interval, group the network traffic that is tracked during the second fifteen minutes into a second time interval, the network traffic that is tracked during the third fifteen minutes into a third time interval, and the network traffic that is tracked during the fourth fifteen minutes into a fourth time interval.

As part of tracking the network traffic, processor 212 of the network device 102 may execute the instructions of network traffic tracking module 222 to, for each data packet in the network traffic encountered by network device 102, determine the packet length of the data packet. The packet length of the data packet is the data size of the data packet, which may be the number of bytes making up the data packet. Because data packets encountered by network device 102 may be of a variety of different data sizes, network device 102 may encounter different data packets having different packet lengths.

Network device 102 may track, for each of a plurality of time intervals, the different packet lengths of the data packets it encounters. Processor 212 of network device 102 may execute the instructions of network traffic tracking module 222 to determine, from the packet length of each data packet encountered by network device 102, the frequency of packet lengths of data packets encountered by network device 102 during the respective time interval. The frequency of packet lengths of data packets encountered by network device 102 during the respective time interval may be the number of times network device 102 encounters data packets of that packet length during the respective time interval. For example, if network device 102 encounters, during a time interval, seven data packets each having a packet length of 20 bytes, the frequency of a packet length of 20 bytes during the time interval is seven.

As part of tracking the network traffic, network device 102 may also track, for each of a plurality of time intervals, the total number of different packet lengths of data packets encountered by network device 102 during the respective time interval. Network device 102 may also execute the instructions of network traffic tracking module 222 to track the total number of different packet lengths of data packets processed by network device 102 for each of a plurality of time intervals. Thus, for each of the plurality of time intervals, processor 212 of the network device 102 may execute the instructions of network traffic tracking module 222 to determine the total number of different packet lengths of data packets encountered by network device 102 during the respective time interval.

Network device 102 may determine, from tracking the different packet lengths of the data packets it encounters and from tracking the frequency of packet lengths of data packets it encounters, the contribution of each of the different packet lengths to the overall network volume during the plurality of time intervals. Processor 212 of the network device 102 may execute the instructions of network traffic tracking module 222 to determine, for each different packet length of data packets encountered by network device 102 during a respective time interval, the network volume (e.g., in bytes) of the packet length for the respective time interval by multiplying the packet length (e.g., a data size in bytes) by the total number of data packets having the packet length during the respective time interval. For example, if network device 102 encounters a total of ten data packets each having a packet length of eight bytes during a time interval, the network volume of the packet length of eight bytes during the time interval is eighty bytes (10 data packets times 8 bytes).

By determining the network volume of each of the different packet lengths of data packets encountered during a respective time interval, processor 212 of the network device 102 may execute the instructions of network traffic tracking module 222 to may determine the total network volume during the respective time interval as the sum of the network volume of each of the different packet lengths of data packets encountered during a respective time interval. Processor 212 of the network device 102 may execute the instructions of network traffic tracking module 222 to determine the contribution of each packet length of data packets to the total network volume for the respective time interval by dividing the total network volume by the network volume of the respective packet length for the respective time interval.

Processor 212 of network device 102 may execute the instructions of network traffic tracking module 222 to determine, based at least in part on the tracked network traffic, a plurality of sample points associated with a plurality of time intervals, where each sample point from the plurality of sample points that is associated with a respective time interval from the plurality of time intervals comprises a count of packet lengths that together contributed to at least a specified portion of total network volume for the respective time interval and a total number of different packet lengths observed during the respective time interval. Thus, network device 102 may determine a sample point for each time interval, and the sample point for a time interval includes the count of packet lengths that together contributed to at least a specified portion of total network volume during a respective time interval and the total number of different packet lengths observed during the respective time interval

The count of packet lengths that together contributed to at least a specified portion of total network volume during a time interval may be the smallest number of different packet lengths that, when the network volumes of the different packet lengths are summed up, equals at least a specified portion of the total network volume during the time interval. For example, if network device 102 encounters data packets having five different packet lengths during a time interval, and the network volumes of the five different packet lengths in bytes are 100 bytes, 100 bytes, 200 bytes, 200 bytes, and 400 bytes, respectively, then the count of packet lengths that together contributed to at least 60% of the total network volume during the time interval may be two, because the network volumes of 400 bytes and 200 bytes associated with two of the five different packet lengths may add up to 600 bytes, which is 60% of the total network volume 1000.

Note that although that the network volumes of 200 bytes, 200 bytes, 100 bytes, and 100 bytes associated with four of the five different packet lengths may also add up to 600 bytes, the count of packet lengths that together contributed to at least a specified portion of total network volume is the smallest number of different packet lengths that, when the network volumes of the different packet lengths are summed up, contributes to at least the specified potion of total network volume for the time interval. Because two is the smallest possible number of different packet lengths that, when the network volumes of the different packet lengths are summed up, contributes to at least 60% of total network volume for the time interval, two is the count of packet lengths that together contributed to at least 60% of the total network volume during the time interval.

Processor 212 of network device 102 may execute instructions to generate, using an unsupervised machine learning mechanism, a plurality of clusters of the plurality of sample points. In particular, processor 212 of network device 102 may execute instructions of network traffic tracking module 222 to derive a set of training data for the unsupervised machine learning mechanism based on at least the portion of the plurality of sample points; and may further execute instructions to generate the plurality of clusters of the plurality of sample points by inputting the set of training data into the unsupervised machine learning mechanism.

Network device 102 may utilize a portion of the sample points as the set of training data for the unsupervised machine learning mechanism and may utilize the remaining portion of the sample points as a set of testing data for the unsupervised machine learning mechanism. For example, network device 102 may utilize 80% of the sample points as the set of training data for the unsupervised machine learning mechanism and may utilize the remaining 20% of the sample points as the set of testing data for the unsupervised machine learning mechanism.

K-means clustering module 224 may be the unsupervised machine learning mechanism used by network device 102 to generate the plurality of clusters of the plurality of sample points. Processor 212 of network device 102 may execute instructions to input the plurality of sample points into k-means clustering module 224, and may execute instructions of k-means clustering module 224 to perform k-means clustering of the plurality of sample points to generate the plurality of clusters of the plurality of sample points. By generating the plurality of clusters of the plurality of sample points, network device 102 performs k-means clustering to assign each of the plurality of sample points into one of the plurality of clusters.

The plurality of clusters generated by network device 102 may each encompass a range of sample points. In particular, because each sample point may be represented as (m, n), where m is the count of packet lengths that together contributes to at least a specified portion of total network volume for the time interval, and n is the total number of different packet lengths observed during the time interval, network device 102 may determine the range of different sample points (m, n) that are encompassed by each of the plurality of clusters. In addition, given a new sample point (m, n), network device 102 may determine the cluster to which the new sample point belongs out of the plurality of clusters, or may even determine whether the new sample point falls outside of the plurality of clusters.

As such, network device 102 may use the plurality of clusters generated via use of k-means clustering module 224 to determine network trends associated with network 150. In particular, processor 212 of network device 102 may execute instructions of network traffic trends module 226 to, in response to determining a plurality of new sample points associated with a plurality of new time intervals based at least in part on the network traffic, determine a network traffic trend for network 150 based at least in part on determining a distribution of the plurality of new sample points within the plurality of clusters

Network trends associated with network 150 may be information regarding the state of network 150, information regarding the network traffic being sent across network 150, information regarding the computing devices (e.g., computing devices 110) connected to network 150, and the like, which may be used to make decisions regarding configuring, managing, or administrating network 150. For example, network device 102 may, based on the network trends of network 150, modify the functioning of the network, change the amount of capacity provisioned for network 150, detect potential security events occurring at network 150, monitor whether security attack mitigation measures have mitigated potential security events at network 150, and the like.

For example, network device 102 may continue to monitor network traffic for new time intervals and may generate new sample points associated with the new time intervals according to the techniques described herein. Network device 102 may determine where the new sample points fall within the plurality of clusters and the distribution of the new sample points within the plurality of clusters to determine the network trend of network 150. For example, network device 102 may determine the status of network capacity that is provisioned for network 150 based at least in part on determining the distribution of the plurality of new sample points within the plurality of clusters.

As network device 102 monitors network traffic for new time intervals and generates new sample points associated with the new time intervals according to the techniques described herein, network device may also determine changes in the distribution of the new sample points during the new time intervals and may determine the network trend for network 150 based on such changes in the distribution of the new sample points during the new time intervals. For example, new sample points associated with the new time intervals may move from primarily being in one cluster of the plurality of clusters to another cluster of the plurality of clusters, or may move away from a particular cluster of the plurality of clusters.

From such changes in the distribution of the new sample points during the new time intervals, network device 102 may be able to determine that new applications are being deployed at computing devices 110 connected to network 150, that a potential security event has occurred at network 150 based at least in part on changes in the distribution of the plurality of new sample points during the plurality of new time intervals, or that security attack mitigation measures have mitigated the potential security event based at least in part on changes in the distribution of the plurality of new sample points during the plurality of new time intervals.

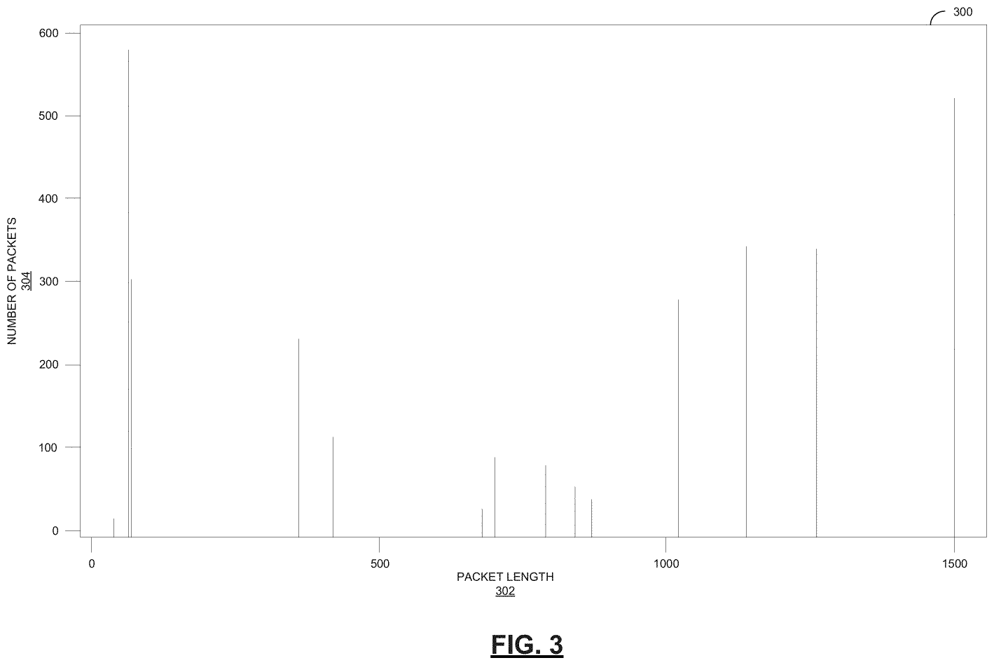

FIG. 3 illustrates an example histogram 300 of the number of packets of each of the packet lengths encountered in an example network 150 during a time interval. The time interval may be a single time interval from a plurality of time intervals during which network device 102 tracks network traffic of network 150. As shown in FIG. 3, histogram 300, the different packet lengths of data packets encountered by network 150 during an example time interval is plotted on the x-axis, while the frequency of the packet lengths of data packets it encounters during the example time interval are plotted on the y-axis.

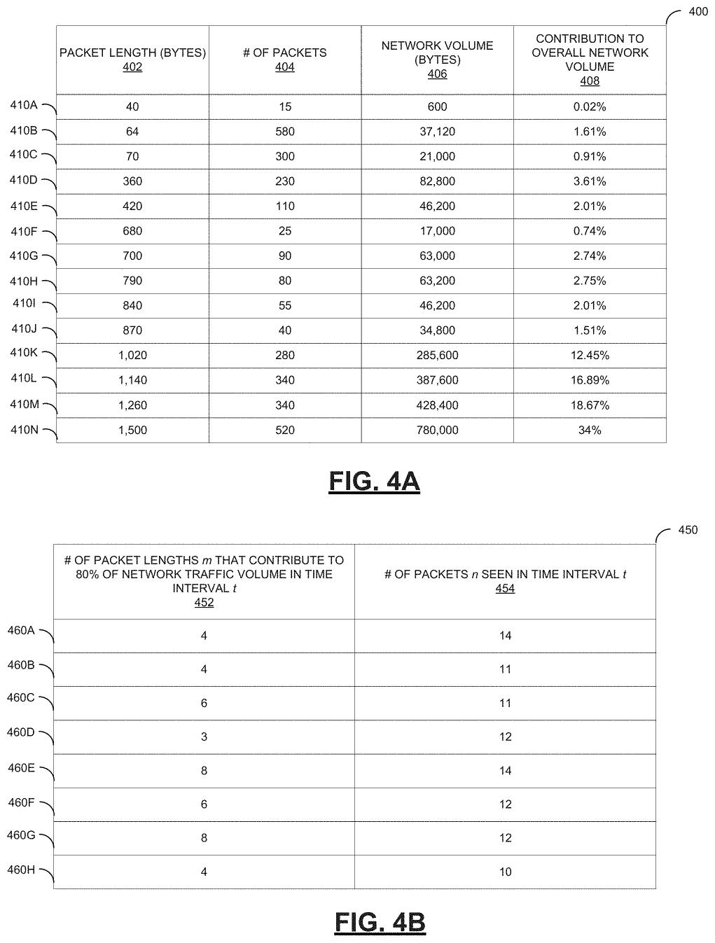

FIG. 4A illustrates an example table 400 of the different packet lengths of data packets encountered by example network device 102 during an example time interval. In particular, FIG. 4A may be a numerical representation of histogram 300 shown in FIG. 3. As shown in FIG. 4A, for each packet length of data packets encountered by network device 102 during an example time interval, network device 102 may track packet length 402, number of packets 404, network volume 406, and contribution to overall network volume 408.

Table 400 includes 14 entries 410A-410N associated with 14 different packet lengths of data packets encountered by network device 102 during a single time interval. For example, entry 410A of table 400 indicates, for a packet length of 40 bytes, 15 data packets of that packet length were encountered by network device 102 during the time interval resulting in a network volume of 600 bytes (40 bytes multiplied by 15 data packets) which contributed to 0.02% of the overall network volume during the time interval. In another example, entry 410B of table 400 indicates, for a packet length of 64 bytes, 580 data packets of that packet length were encountered by network device 102 during the time interval resulting in a network volume of 37,120 bytes (64 bytes multiplied by 580 data packets) which contributed to 1.61% of the overall network volume during the time interval. In a further example, entry 410C of table 400 indicates, for a packet length of 70 bytes, 300 data packets of that packet length were encountered by network device 102 during the time interval resulting in a network volume of 21,000 bytes (70 bytes multiplied by 300 data packets) which contributed to 0.91% of the overall network volume during the time interval.

Network device 102 may determine a sample point associated with the time interval based on the information included in table 400. As discussed above, a sample point associated with a time interval includes a count of packet lengths that together contributed to at least a specified portion of total network volume for the time interval and a total number of different packet lengths observed during the time interval. As table 400 includes fourteen different packet lengths, the total number of different packet lengths observed during the time interval may be fourteen.

Further, to determine the count of packet lengths that together contributed to at least a specified portion of total network volume for the time interval, given an example of the specified portion of total network volume being 80% of the total network volume, network device 102 may determine the smallest number of different packet lengths whose associated network volumes would add up to at least 80%. In the example of FIG. 4A, the network volumes of four packet lengths of 1,500 bytes, 1,260 bytes, 1,140 bytes, and 1,020 bytes shown in entries 410N, 410M, 410L, and 410K, respectively, add up to over 80% of the total network volume for the time interval (e.g., 34%, 18.67%, 16.89%, and 12.45% adds up to 82.01%). As such, network device 102 may determine that the count of packet lengths that together contributed to at least 80% of total network volume for the time interval to be four.

FIG. 4B illustrates an example table 450 of example sample points associated with an example plurality of time intervals. As shown in example FIG. 4B, table 450 may be an example table including eight entries 460A-460H of eight sample points associated with eight fifteen-minute intervals in a two-hour period, and table 450 indicates a count of packet lengths that together contributed to at least 80% of total network volume for the time interval 452 and a total number of different packet lengths observed during the time interval 454 for each of the sample points in entries 460A-460H. As such, each sample point may be represented as (m, n), where m is the count of packet lengths that together contributes to at least 80% of total network volume for the time interval, and n is the total number of different packet lengths observed during the time interval. For example, entry 460A may correspond to the time interval described in FIG. 4A, where a count of packet lengths that together contributes to at least 80% of total network volume for the time interval is four, and the total number of different packet lengths observed during the time interval is fourteen, resulting in a sample point of (4, 14).

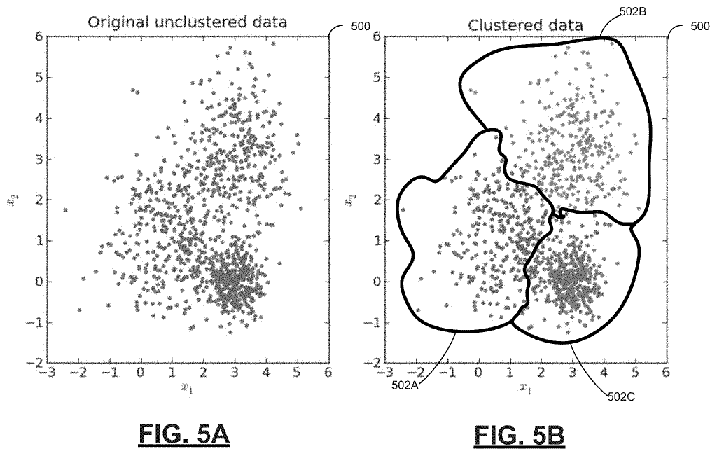

FIG. 5A illustrates an example visual representation of example sample points associated with example time intervals that are plotted in example graph 500. As shown in FIG. 5A, sample points that are determined by network device 102 according to the techniques disclosed herein for a plurality of time intervals, including the sample points illustrated in table 450 of FIG. 4B, are plotted in graph 500. In graph 500, the x-axis, labeled herein as x1, represents the count of packet lengths that together contributes to at least 80% of total network volume for the time interval, and the y-axis, labeled herein as x2, represents the total number of different packet lengths observed during the time interval. In addition, the sample points illustrated in graph 500 may be normalized so that they are within the ranges of the x-axis and the y-axis.

FIG. 5B illustrates example clusters 502A-502C of example sample points plotted in example graph 500 of FIG. 5A. As shown in FIG. 5B, the sample points plotted in example graph 500 may be clustered, such as by using a k-means clustering unsupervised machine learning algorithm, to generate clusters 502A-502C. In the example of FIG. 5B, cluster 502A is a rare cluster where the sample points in cluster 502A are associated with time intervals in which the percentage of different packet lengths that contribute to the majority of the network traffic is low. In other words, cluster 502A includes sample points where a relatively low number of different packet lengths (e.g., less than 30% of the different packet lengths) represent a large portion (e.g., greater than or equal to 80%) of the network volume during the respective time intervals.

Cluster 502C is a dense cluster where the sample points in cluster 502B are associated with time intervals in which the percentage of different packet lengths that contribute to the majority of the network traffic is high. In other words, cluster 502B includes sample points where a relatively high number of different packet lengths (e.g., greater than 70% of the different packet lengths) together represent a large portion (e.g., greater than or equal to 80%) of the network volume during the respective time intervals.

Cluster 502B is an even cluster where the sample points in cluster 502B are associated with time intervals in which the percentage of different packet lengths that contribute to the majority of the network traffic is neither high nor low. In other words, cluster 502C includes sample points where the number of different packet lengths that together represent a large portion (e.g., greater than or equal to 80%) of the network volume during the respective time intervals is neither relatively high nor relatively low (e.g., is between 30% to 70% of the different packet lengths).

Network device 102 may utilize clusters 502A-502C to determine a network trend of network 150 by monitoring network traffic of network 150C for network traffic during a plurality of new time intervals, determining new sample points associated with the new time intervals, and determining a distribution of the new sample points within clusters 502A-502C. Network device 102 may determine the status of the network capacity that is provisioned for network 150 based at least in part on determining the distribution of the plurality of new sample points within the plurality of clusters 502A-502C. For example, if the new sample points associated with the plurality of new time intervals fall mainly within rare cluster 502A, such that a specified portion (e.g., above 70%) of the new sample points fall within rare cluster 502A, network device may determine that network 150 has sufficient provisioned network capacity to handle the network traffic.

Network device 102 may also determine the network traffic trend for network 150 based at least in part on changes in the distribution of the plurality of new sample points during the plurality of new time intervals. Such changes may include the new sample points associated with the new plurality of time intervals moving from one cluster of clusters 502A-502C to another cluster of clusters 502A-502C as time passes during the plurality of new time intervals.

For example, network device 102 may determine that new sample points are moving from rare cluster 502A to even cluster 502B as time passes during the plurality of new time intervals. Network device 102 may, in response to determining that the new sample points are moving from rare cluster 502A to even cluster 502B as time passes during the plurality of new time intervals, that new software applications are being deployed or trialed at computing devices 110 connected to network 150.

In another example, network device 102 may determine a sudden increase in new sample points moving into dense cluster 502C. Network device 102 may make that a determination when there is an increase in new sample points falling within dense cluster 502C in a short amount of time, such as in the space of fewer than two or three intervals in the plurality of new time intervals. Network device 102 may, in response to determining the sudden increase in new sample points moving into dense cluster 502C, determine that a potential security event has occurred in network 150, such that an administrator of network 150 may have to review existing security provisions in network 150.

In a further example, network device 102 may determine the elimination of new sample points in dense cluster 502C. Network device 102 may make that a determination when new sample points falling within dense cluster 502C are reduced over the plurality of new time intervals. Network device 102 may, in response to determining the elimination of new sample points into dense cluster 502C, determine that security attack mitigation measures have mitigated the potential security event in network 150.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

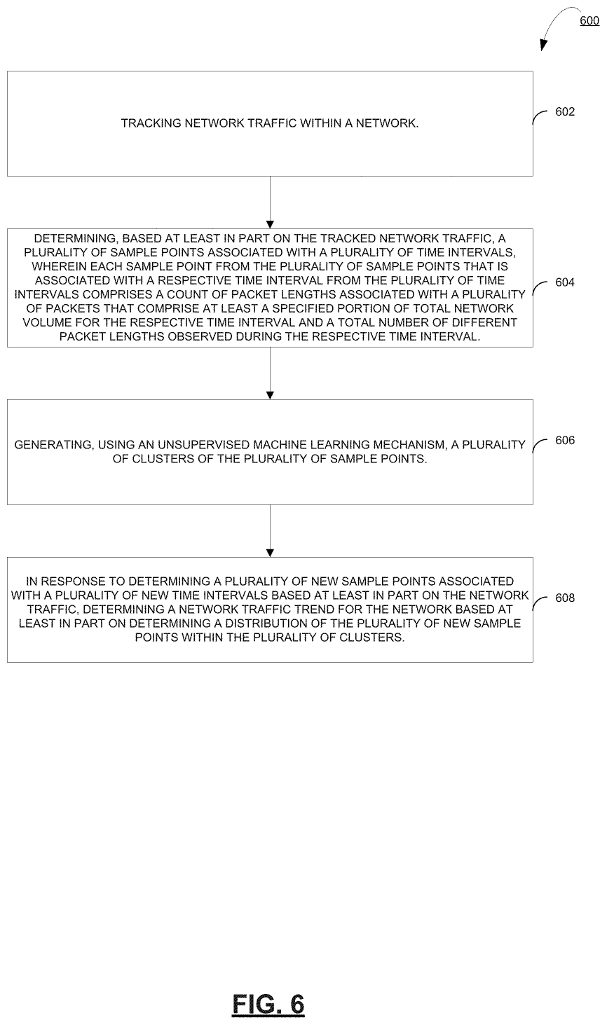

FIG. 6 illustrates an example process 600 for determining network traffic trends using the example network device 102 of FIGS. 1 and 2. While FIG. 6 is described with reference to FIGS. 1 and 2, it should be noted that the process steps of FIG. 6 may be performed by other systems.

The process 600 begins by proceeding to step 602 where network device 102 may track network traffic within network 150. The process 600 proceeds to step 604 where network device 102 may determine, based at least in part on the tracked network traffic, a plurality of sample points associated with a plurality of time intervals, wherein each sample point from the plurality of sample points that is associated with a respective time interval from the plurality of time intervals comprises a count of packet lengths associated with a plurality of packets that comprise at least a specified portion of total network volume for the respective time interval and a total number of different packet lengths observed during the respective time interval. In some examples, the specified portion of total network volume is 80% of the total network volume.

The process 600 proceeds to step 606 where network device 102 may generate, using an unsupervised machine learning mechanism, a plurality of clusters of the plurality of sample points. In some examples, generating, using the unsupervised machine learning mechanism, the plurality of clusters of the plurality of sample points further includes deriving a set of training data for the unsupervised machine learning mechanism based on at least a portion of the plurality of sample points and generating the plurality of clusters of the plurality of sample points by inputting the set of training data into the unsupervised machine learning mechanism. In some examples, the machine learning mechanism may include a k-means clustering unsupervised machine learning mechanism, and generating the plurality of clusters of the plurality of sample points may include performing, using the k-means clustering unsupervised machine learning mechanism, k-means clustering of the plurality of sample points. In some examples, the plurality of clusters includes a rare cluster, an even cluster, and a dense cluster.

The process 600 proceeds to step 608 where network device 102 may, in response to determining a plurality of new sample points associated with a plurality of new time intervals based at least in part on the network traffic, determining a network traffic trend for the network 150 based at least in part on determining a distribution of the plurality of new sample points within the plurality of clusters. In some examples, determining the network traffic trend for the network 150 based at least in part on determining the distribution of the plurality of new sample points within the plurality of clusters may further include determining a status of network capacity that is provisioned for the network 150 based at least in part on determining the distribution of the plurality of new sample points within the plurality of clusters.

In some examples, determining the network traffic trend for the network 150 based at least in part on determining the distribution of the plurality of new sample points within the plurality of clusters may further include determining the network traffic trend for the network 150 based at least in part on changes in the distribution of the plurality of new sample points during the plurality of new time intervals. In some examples, determining the network traffic trend for the network 150 based at least in part on changes in the distribution of the plurality of new sample points during the plurality of new time intervals further includes determining that new applications are being deployed at computing devices 110 connected to the network 150.

In some examples, determining the network traffic trend for the network 150 based at least in part on changes in the distribution of the plurality of new sample points during the plurality of new time intervals further includes determining that a potential security event has occurred at the network 150 based at least in part on changes in the distribution of the plurality of new sample points during the plurality of new time intervals. In some examples, determining the network traffic trend for the network 150 based at least in part on changes in the distribution of the plurality of new sample points during the plurality of new time intervals further includes determining that security attack mitigation measures have mitigated the potential security event based at least in part on changes in the distribution of the plurality of new sample points during the plurality of new time intervals.

### Hardware Overview

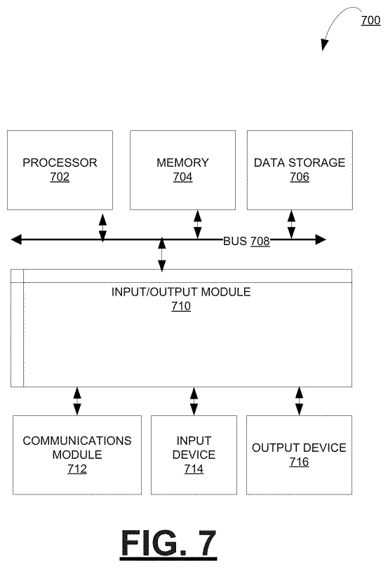

FIG. 7 is a block diagram illustrating an example computer system 700 with which network device 102 of FIGS. 1 and 2 can be implemented. In certain aspects, the computer system 700 may be implemented using hardware or a combination of software and hardware, either in a dedicated server, or integrated into another entity, or distributed across multiple entities.

Computer system 700 (e.g., network device 102 and computing devices 110) includes a bus 708 or other communication mechanism for communicating information, and a processor 702 (e.g., processor 212 and 236) coupled with bus 708 for processing information. According to one aspect, the computer system 700 can be a cloud computing server of an IaaS that is able to support PaaS and SaaS services. According to one aspect, the computer system 700 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. By way of example, the computer system 700 may be implemented with one or more processors 702. Processor 702 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704 (e.g., memory 220) such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry. Expansion memory may also be provided and connected to computer system 700 through input/output module 710, which may include, for example, a SIMM (Single In Line Memory Module) card interface. Such expansion memory may provide extra storage space for computer system 700, or may also store applications or other information for computer system 700. Specifically, expansion memory may include instructions to carry out or supplement the processes described above, and may include secure information also. Thus, for example, expansion memory may be provided as a security module for computer system 700, and may be programmed with instructions that permit secure use of computer system 700. In addition, secure applications may be provided via the SIMM cards, along with additional information, such as placing identifying information on the SIMM card in a non-hackable manner.

The instructions may be stored in the memory 704 and implemented in one or more computer program products, e.g., one or more modules of computer program instructions encoded on a computer readable medium for execution by, or to control the operation of, the computer system 700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Example input/output modules 710 include data ports such as USB ports. In addition, input/output module 710 may be provided in communication with processor 702, so as to enable near area communication of computer system 700 with other devices. The input/output module 710 may provide, for example, for wired communication in some implementations, or for wireless communication in other implementations, and multiple interfaces may also be used. The input/output module 710 is configured to connect to a communications module 712. Example communications modules 712 (e.g., communications modules 218) include networking interface cards, such as Ethernet cards and modems.

The components of the system can be interconnected by any form or medium of digital data communication, e.g., a communication network. The communication network (e.g., communication network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

For example, in certain aspects, communications module 712 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, communications module 712 sends and receives electrical, electromagnetic or optical signals that carry digital data streams representing various types of information. The network link typically provides data communication through one or more networks to other data devices. For example, the network link of the communications module 712 may provide a connection through local network to a host computer or to data equipment operated by an Internet Service Provider (ISP). The ISP in turn provides data communication services through the world wide packet data communication network now commonly referred to as the “Internet”. The local network and Internet both use electrical, electromagnetic or optical signals that carry digital data streams. The signals through the various networks and the signals on the network link and through communications module 712, which carry the digital data to and from computer system 700, are example forms of transmission media.

Computer system 700 can send messages and receive data, including program code, through the network(s), the network link and communications module 712. In the Internet example, a server might transmit a requested code for an application program through Internet, the ISP, the local network and communications module 712. The received code may be executed by processor 702 as it is received, and/or stored in data storage 706 for later execution.

In certain aspects, the input/output module 710 is configured to connect to a plurality of devices, such as an input device 714 and/or an output device 716. Example input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 716 include display devices, such as a LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the user. The output device 716 may comprise appropriate circuitry for driving the output device 716 to present graphical and other information to a user.

According to one aspect of the present disclosure, network device 102 can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in main memory 704 causes processor 702 to perform the process steps described herein. One or more processors in a multi-processing arrangement may also be employed to execute the sequences of instructions contained in memory 704. Processor 702 may process the executable instructions and/or data structures by remotely accessing the computer program product, for example by downloading the executable instructions and/or data structures from a remote server through communications module 712 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

Computing system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processor 702 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 708. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of” A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for determining network traffic trends, comprising:
tracking network traffic within a network;
determining, based at least in part on the tracked network traffic, a plurality of sample points associated with a plurality of time intervals, wherein each sample point from the plurality of sample points that is associated with a respective time interval from the plurality of time intervals comprises a count of packet lengths associated with a plurality of packets that comprise at least a specified portion of total network volume for the respective time interval and a total number of different packet lengths observed during the respective time interval;
generating, using an unsupervised machine learning mechanism, a plurality of clusters of the plurality of sample points; and
in response to determining a plurality of new sample points associated with a plurality of new time intervals based at least in part on the network traffic, determining a network traffic trend for the network based at least in part on determining a distribution of the plurality of new sample points within the plurality of clusters.

2. The computer-implemented method of claim 1, wherein generating, using the unsupervised machine learning mechanism, the plurality of clusters of the plurality of sample points further comprises:
deriving a set of training data for the unsupervised machine learning mechanism based on at least a portion of the plurality of sample points; and
generating the plurality of clusters of the plurality of sample points by inputting the set of training data into the unsupervised machine learning mechanism.

3. The computer-implemented method of claim 2,
wherein the unsupervised machine learning mechanism comprises a k-means clustering unsupervised machine learning mechanism; and
wherein generating the plurality of clusters of the plurality of sample points comprises performing, using the k-means clustering unsupervised machine learning mechanism, k-means clustering of the plurality of sample points.

4. The computer-implemented method of claim 1, wherein determining the network traffic trend for the network based at least in part on determining the distribution of the plurality of new sample points within the plurality of clusters further comprises:
determining a status of network capacity that is provisioned for the network based at least in part on determining the distribution of the plurality of new sample points within the plurality of clusters.

5. The computer-implemented method of claim 1, wherein determining the network traffic trend for the network based at least in part on determining the distribution of the plurality of new sample points within the plurality of clusters further comprises:
determining the network traffic trend for the network based at least in part on changes in the distribution of the plurality of new sample points during the plurality of new time intervals.

6. The computer-implemented method of claim 5, wherein determining the network traffic trend for the network based at least in part on changes in the distribution of the plurality of new sample points during the plurality of new time intervals further comprises:
determining that new applications are being deployed at computing devices connected to the network.

7. The computer-implemented method of claim 5, wherein determining the network traffic trend for the network based at least in part on changes in the distribution of the plurality of new sample points during the plurality of new time intervals further comprises:
determining that a potential security event has occurred at the network based at least in part on changes in the distribution of the plurality of new sample points during the plurality of new time intervals.

8. The computer-implemented method of claim 5, wherein determining the network traffic trend for the network based at least in part on changes in the distribution of the plurality of new sample points during the plurality of new time intervals s further comprises:
determining that security attack mitigation measures have mitigated the potential security event based at least in part on changes in the distribution of the plurality of new sample points during the plurality of new time intervals.

9. The computer-implemented method of claim 1, wherein the plurality of clusters comprises a rare cluster, an even cluster, and a dense cluster.

10. The computer-implemented method of claim 1, wherein the specified portion of total network volume is 80% of the total network volume.

11. A system for determining network traffic trends:
a memory comprising instructions; and
a processor configured to execute the instructions which, when executed, cause the processor to:
track network traffic within a network;
determine, based at least in part on the tracked network traffic, a plurality of sample points associated with a plurality of time intervals, wherein each sample point from the plurality of sample points that is associated with a respective time interval from the plurality of time intervals comprises a count of packet lengths associated with a plurality of packets that comprise at least a specified portion of total network volume for the respective time interval and a total number of different packet lengths observed during the respective time interval;
generate, using an unsupervised machine learning mechanism, a plurality of clusters of the plurality of sample points; and
in response to determining a plurality of new sample points associated with a plurality of new time intervals based at least in part on the network traffic, determine a network traffic trend for the network based at least in part on determining a distribution of the plurality of new sample points within the plurality of clusters.

12. The system of claim 11, wherein the processor configured to execute the instructions that cause the processor to generate, using the unsupervised machine learning mechanism, the plurality of clusters of the plurality of sample points is further configured to execute the instructions that cause the processor to:
derive a set of training data for the unsupervised machine learning mechanism based on at least a portion of the plurality of sample points; and
generate the plurality of clusters of the plurality of sample points by inputting the set of training data into the unsupervised machine learning mechanism.

13. The system of claim 12,
wherein the unsupervised machine learning mechanism comprises a k-means clustering unsupervised machine learning mechanism; and
wherein the processor configured to execute the instructions that cause the processor to generate the plurality of clusters of the plurality of sample points is further configured to execute the instructions that cause the processor to perform, using the k-means clustering unsupervised machine learning mechanism, k-means clustering of the plurality of sample points

14. The system of claim 11, wherein the processor configured to execute the instructions that cause the processor to determine the network traffic trend for the network based at least in part on determining the distribution of the plurality of new sample points within the plurality of clusters is further configured to execute the instructions that cause the processor to determine a status of network capacity that is provisioned for the network based at least in part on determining the distribution of the plurality of new sample points within the plurality of clusters.

15. The system of claim 11, wherein the processor configured to execute the instructions that cause the processor to determine the network traffic trend for the network based at least in part on determining the distribution of the plurality of new sample points within the plurality of clusters is further configured to execute the instructions that cause the processor to determine the network traffic trend for the network based at least in part on changes in the distribution of the plurality of new sample points during the plurality of new time intervals.

16. The system of claim 15, wherein the processor configured to execute the instructions that cause the processor to determine the network traffic trend for the network based at least in part on changes in the distribution of the plurality of new sample points during the plurality of new time intervals is further configured to execute the instructions that cause the processor to determine that new applications are being deployed at computing devices connected to the network.

17. The system of claim 15, wherein the processor configured to execute the instructions that cause the processor to determine the network traffic trend for the network based at least in part on changes in the distribution of the plurality of new sample points during the plurality of new time intervals is further configured to execute the instructions that cause the processor to determine that a potential security event has occurred at the network based at least in part on changes in the distribution of the plurality of new sample points during the plurality of new time intervals.

18. The system of claim 15, wherein the processor configured to execute the instructions that cause the processor to determine the network traffic trend for the network based at least in part on changes in the distribution of the plurality of new sample points during the plurality of new time intervals is further configured to execute the instructions that cause the processor to determine that security attack mitigation measures have mitigated the potential security event based at least in part on changes in the distribution of the plurality of new sample points during the plurality of new time intervals.

19. The system of claim 11, wherein the plurality of clusters comprises a rare cluster, an even cluster, and a dense cluster.

20. A non-transitory machine-readable storage medium comprising machine-readable instructions for causing a processor to execute a method for determining network trends comprising:
tracking network traffic within a network;
determining, based at least in part on the tracked network traffic, a plurality of sample points associated with a plurality of time intervals, wherein each sample point from the plurality of sample points that is associated with a respective time interval from the plurality of time intervals comprises a count of packet lengths associated with a plurality of packets that comprise at least a specified portion of total network volume for the respective time interval and a total number of different packet lengths observed during the respective time interval;
generating, using an unsupervised machine learning mechanism, a plurality of clusters of the plurality of sample points; and
in response to determining a plurality of new sample points associated with a plurality of new time intervals based at least in part on the network traffic, determining a network traffic trend for the network based at least in part on determining a distribution of the plurality of new sample points within the plurality of clusters.
